(19) United States
(12) Patent Application Publication
(10) Pub. No.: US 2012/0198969 A1
(43) Pub. Date: Aug. 9, 2012

(54) DEVICE AND METHOD FOR OPENING CONTAINERS OF LIQUIDS

(75) Inventor: Ottorino Casonato, Castelfranco Veneto (IT)

(73) Assignee: STEELCO SPA, Riese Pio X (IT)

(21) Appl. No.: 13/501,353

(22) PCT Filed: Oct. 11, 2010
(86) PCT No.: PCT/EP10/65158

§ 371 Date: Apr. 11, 2012

(30) Foreign Application Priority Data
Oct. 13, 2009 (IT) UD2009A000182

(51) Int. Cl. B67B 7/00; B67B 7/14

(52) U.S. Cl. 81/3.2; 53/492

(57) ABSTRACT

Device (10) and method for opening containers (12) containing liquids, to remove lids (11) or capsules from the relative containers (12). The lids (11) are conformed so as to define a spout (11a) with a hole in it to allow the liquid to come out of the container (12). The device (10) comprises one or more extraction members (15), each provided with an air passage pipe (17) associable with at least part of the spout (11a) in order to selectively introduce pressurized air inside a relative container (12). A closing valve member (30) is disposed along the air passage pipe (17), and is selectively openable when the extraction member (15) is associated with a relative spout (11a), and wherein the introduction of pressurized air inside the container (12) determines a relative movement of separation of the lid (11) and the container (12).

### FIELD OF THE INVENTION

The present invention concerns a device, and the relative method, to open or de-lid containers for liquids, for example but not exclusively bottles, feeding bottles, drinking troughs or other containers or receptacles for feeding animals. In particular, with the present invention it is possible to open the containers in a simple and efficient way, in order to prepare them for washing and/or sterilization, for example, but not only, in a partly automated washing line.

### BACKGROUND OF THE INVENTION

Machines are known, at least partly automated, or manual, used for washing containers for liquids, for example, but not only, bottles, feeding bottles, drinking troughs or others, which can be used for feeding animals such as guinea pigs or laboratory rodents or others.

It is known that, before washing, the containers have been closed with suitable lids or capsules, which lids are shaped with a spout to allow the animal to consume the liquid contained in the container, and that after washing they must be supplied closed and refilled with new liquid.

Such washing machines are structured with several operating stations disposed in line with respect to each other, including a loading station to load the closed containers, a removal station to remove the capsules from the containers, or delidding station, a washing station, a refilling station and a closing station to close the washed and refilled containers by means of said capsules.

It is also known to dispose and group together a plurality of containers in suitable washing baskets, provided with relative containment cells, so as to keep the containers with a desired disposition during all the operating steps of the machine.

It is also known to provide a single treatment, or in disorderly or non-homogenous groups, of the containers, for example in machines which are mainly manual and have reduced capacity.

The lids are normally attached to the containers in a watertight manner. In known solutions which provide the removal station, the closed containers are opened by removing the lids by means of an extractor.

In general however, known extractors are complex and difficult to manage, they need a lot of complex manual intervention, and do not allow to hold the lid after the containers have advanced toward the washing station.

Purpose of the present invention is to achieve a device and perfect a method which allow to open the containers simply, economically and efficiently, which reduce the performance times to a minimum and which overcome the disadvantages of the state of the state of the art.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, an opening device according to the present invention is applied to a removal station used for example in an at least partly automated machine, to process containers of liquid, to remove the relative lids or capsules, equipped with a spout through which the liquid exits.

The invention is applied particularly, advantageously but not exclusively, to simultaneously remove a plurality of lids of containers which are adjacent to each other, for example disposed in a basket or suchlike.

According to a characteristic feature of the present invention, the opening device comprises one or more extraction members, each provided with an air passage pipe conformed so as to allow the passage of pressurized air through it, the air passage pipe being provided with at least a housing segment for at least part of the spout of the lid.

Each extraction member also comprises a selective closing member of the air passage pipe, disposed upstream of the housing segment of the spout, and able to temporarily and selectively allow or prevent the passage of the air through said housing segment and therefore through the hole of the spout.

The present invention also provides that the housing segment is made so that the spout enters into the air passage pipe until it reaches a condition of cooperation with the closing member, automatically taking it to an open operating condition, at the moment of coupling of the extraction member and the container, substantially without any manual intervention by an operator.

In the open operating condition, the closing member thus allows the passage of the pressurized air through the air passage pipe so as to allow the air to pass through the housing segment and then through the hole of the spout as far as inside the container, in order to increase the internal pressure thereof until a relative movement of separation is determined between the lid and the container.

In this way, a jet of pressurized air is blown simply and effectively into the container so as to remove the lid, and in order to obtain, as a reaction, a pressure force inside the container which determines a certain relative separation of the lid and the container, which allows the lid to be removed.

The solution according to the present invention is thus particularly advantageous both in at least partly automated machines, that is, of the type able to move the containers automatically in baskets along relative automated movement members, and also in manual plants, in which the stations are operatively separate and the containers are processed individually or in small groups, even not homogeneous, and are then transported toward subsequent stations for washing, filling and re-sealing.

According to a variant, the opening device according to the present invention also comprises holding means, associated with the air passage pipe for at least part of the housing segment and selectively movable to hold the spout temporarily inside the housing segment.

The presence of the holding means allows to hold the lid constrained to the air passage pipe, after it has been removed from the neck of the container, while the containers to be washed are moved, and to release the lid at a subsequent moment, for example in a zone used for sterilization and re-sealing.

According to a variant, the closing member comprises a slider element provided with a cavity open toward the housing segment and with one or more lateral delivery holes. The cavity and the delivery holes are able to put the housing segment and the remaining part of the air passage pipe into fluid communication.

Advantageously, the closing member also comprises an elastic element and an abutment element, the latter disposed fixed inside the air passage pipe.

The slider element is selectively mobile with respect to the abutment element, so that the lateral delivery holes can pass from a position outside the abutment element, and coinciding with the open operating condition, to a position inside the abutment element, and coinciding with a closed operating condition, in which the closing member prevents the passage of pressurized air through the housing segment of the air passage pipe so as to interrupt the passage of air through the hole of the spout as far as inside the container.

The elastic element is interposed mechanically between the slider element and the abutment element and is able to keep the slider element normally in the closed operating condition.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a partial schematic lateral view of a removal station comprising the opening device for containers of liquids according to the present invention;

FIG. 2 is a section of an opening device according to the present invention.

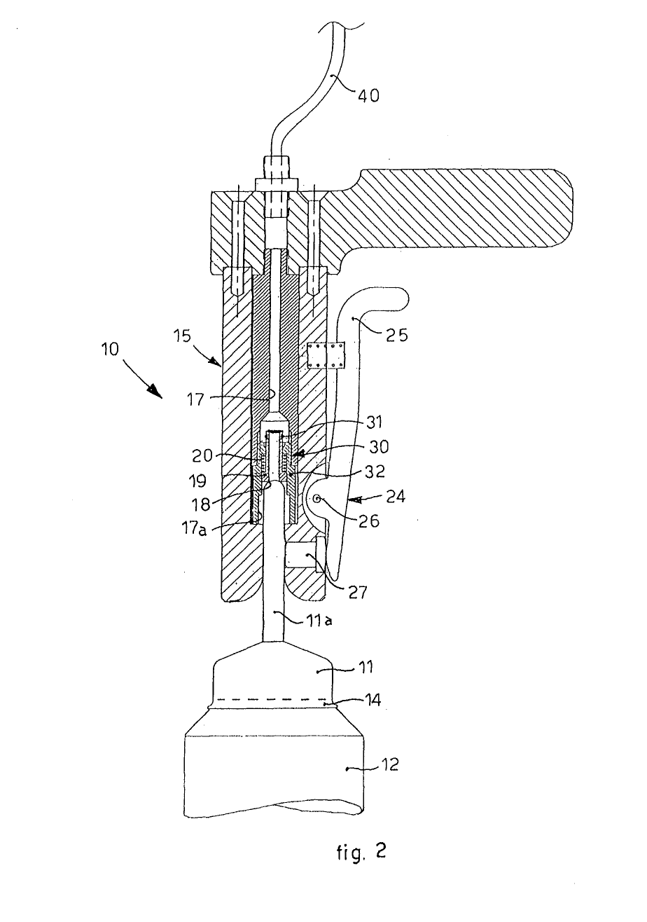

To facilitate comprehension, the same reference numbers are used, where possible, to identify identical common elements in the drawings. It should be understood that elements and characteristics of one form of embodiment can conveniently be incorporated into other forms of embodiment without any further clarification.

### DETAILED DESCRIPTION OF A PREFERENTIAL FORM OF EMBODIMENT

With reference to the attached drawings, an opening device 10 according to the present invention is used for processing feeding bottles 12, for feeding small animals such as guinea pigs, mice, hamsters and others, for example used in pharmaceutical research laboratories.

The bottles 12 are normally closed at the upper part by means of relative metal lids 11 or capsules conformed so as to define a through holed spout 11a from which the animal consumes the liquid contained therein.

In this case, each bottle 12 has a closing neck on which a packing 14 is annularly and externally disposed; the packing 14 is able to define the watertight seal of the closure, once the lid 11 is disposed to close the bottle 12.

In particular, the opening device 10 according to the present invention allows to open the bottles 12 in a simple and almost completely automated manner, in order to prepare them for the subsequent washing and filling steps, actuated by a machine for processing the bottles 12, not shown here, with which the device 10 is operatively associated.

In this case, the bottles 12 are fed to the opening device 10 by means of a conveyor belt 21 disposed in a determinate direction of feed.

It cannot be excluded that the device 10 can equally be applied to an individual station to remove the lids 11, not necessarily integrated in an automated machine.

In the form of embodiment shown here, the bottles 12 are disposed inside relative containing baskets 23, which are typically provided with a plurality of cells having a desired orderly disposition, for example in rows and columns.

Each cell is conformed to accommodate a relative bottle 12 and keep it angularly constrained and in a determinate orderly position with respect to the other bottles 12.

The opening device 10 can be mounted suspended on a bridge structure, not shown, above the conveyor belt 21, and consists of a plurality of elements geometrically disposed coherent with the disposition of the bottles 12 in the baskets 23.

The opening device 10 comprises a plurality of extraction heads 15 of the pneumatic type, suitable to be individually taken into cooperation with the relative spouts 11a of each lid 11, in order to selectively blow pressurized air inside the bottles 12 and to cause the at least partial release of the lids 11 from the neck of the relative bottles 12.

The extraction heads 15 are also selectively movable in a substantially vertical direction by means of a relative actuator 16, so as to be able to be lifted and lowered with respect to the bottles 12 on which they act, with a linear movement, at least in the course of the cycle to remove the lids 11.

The extraction heads 15 are provided singly or in groups and act on the spouts 11a of the lids 11 according to the positioning arrangement of the bottles 12 in the basket 23.

Each extraction head 15 has a substantially cylindrical conformation and comprises inside it an air passage pipe 17, having conformation and sizes correlated to the spouts 11a of the lids 11.

In particular, each air passage pipe 17 is open toward the outside through an entrance 17a with a larger diameter, and comprises a housing segment 18 able to house part of the spout 11a.

Each extraction head 15 also comprises a selective closing member 30 of the air passage pipe 17, disposed upstream of the housing segment 18 and along said air passage pipe.

The closing member 30 comprises a slider cylinder 19 provided with a cavity open toward the housing segment 18 and with delivery holes 31 made on the lateral wall in proximity with its upper portion.

The closing member 30 also comprises a contrasting spring 20 and an abutment cylinder 32 disposed fixed inside the air passage pipe 17. The spring 20 is mechanically interposed between the slider cylinder 19 and the abutment cylinder 32.

In the non-operative condition, the spring 20 is inactive and the slider cylinder 19 is in a position where the delivery holes 31 are in a closed condition in contact with the surface of the abutment element 32.

Once the spout 11a has been partly inserted inside the housing segment 18, the slider cylinder 19 is thrust upward by the end of the spout 11a. The thrust is partly contrasted by the spring 20 which keeps the slider cylinder 19 thrusting against the spout 11a, guaranteeing that the latter is sealed by part of the slider cylinder 19.

The movement of the slider cylinder 19 consequently determines the movement of the delivery holes 31 into a region of the air passage pipe 17 in which the abutment element 32 is not present, thus determining the opening of the delivery holes 31.

In this condition pressurized air is blown, by means of a feed pipe 40 connected to a source of pressurized gas (not shown), inside the air passage pipe 17.

The pressurized air reaches the inside of the bottle 12 through the delivery holes 31, the housing segment 18 and the spout 11a, so as to increase the pressure inside the bottle 12 until it causes, due to the force of reaction, the lid 11 to be lifted as far as at least above the packing 14.

The opening device 10 is also provided with a holding member 24, of the gripper type, to temporarily hold the spout 11a inside the air passage pipe 17 during and after the opening operation.

In this case, the holding member 24 comprises a lever 25 pivoted to the lateral wall of the extraction head 15 by means of a pin 26 with a spring which allows it a movement of approach/separation to/from the extraction head 15, and a peg 27 attached to the lower end portion of the lever 25.

The peg 27 is selectively movable linearly inside a transverse hole made on the lateral wall of the extraction head 15, in correspondence with the housing segment 18.

The opening device 10 according to the present invention functions as follows.

Once the bottles 12 have reached the desired position under the extraction heads 15 by means of the conveyor belt 21, the linear actuator 16 is activated to determine a linear approach movement of the extraction heads 15 and the spouts 11a of the relative bottles 12.

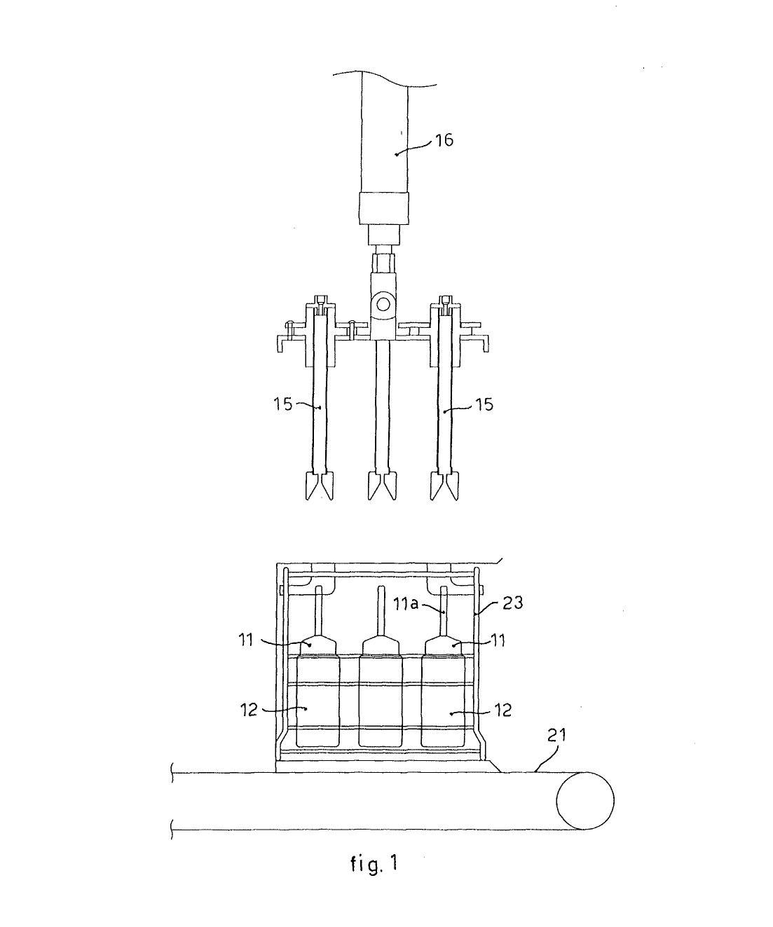

The example shown in FIG. 1 shows three bottles 12 which can be uncapped simultaneously: it is obvious that this simultaneous opening can serve for any desired number of bottles 12 contained in order in the basket 23.

After each spout 11a has been inserted into the housing segment 18 of the relative extraction head 15, the peg 27 is thrust elastically toward the outside, remaining in contact with the spout 11 a and exerting a slight pressure upon it; the slider cylinder 19 is thrust upward by the tip of the spout 11a, which causes the delivery holes 31 to open. This causes the pressurized air to pass inside the bottle 12 through the spout 11a, until the pressure inside it overcomes the sealing force of the packing 14 and causes the lid 11 to be raised and become released from the packing 14.

After opening, the extraction heads 15 are raised with respect to the bottles 12 by the actuator 16, which takes the lid 11 backward with it thanks to the retention exerted by the peg 27 on the relative spouts 11a.

The containing basket 23 is then made to move forward by means of the belt 21 toward the washing station.

By acting manually or automatically on the lever 25, the lids 11 can then be released by the peg 27, for example, onto a tray suitably positioned under the extraction heads 15, and which is then moved toward a station to wash and sterilize the lids 11, while a new basket 23 with bottles 12 to be uncapped can be moved under the extraction heads 15.

It is clear that modifications and/or additions of parts or steps may be made to the opening device 10 and the relative method as described heretofore, without departing from the field and scope of the present invention.

For example, it comes within the field of the present invention to provide that a relative linear actuator 16 is associated with each extraction head 15, in order to impart on each extraction head 15 an independent linear movement

It is also clear that, although the present invention has been described with reference to some specific examples, a person of skill in the art shall certainly be able to achieve many other equivalent forms of opening device and method, having the characteristics as set forth in the claims and hence all coming within the field of protection defined thereby.

1. An opening device for containers containing liquids, to remove lids or capsules from the relative containers, said lids being conformed so as to define a spout with a hole in it to allow the liquid to come out of the container, wherein it comprises one or more extraction members, each provided with an air passage pipe associable with at least part of the spout in order to selectively introduce pressurized air inside a relative container, a closing valve member being disposed along said air passage pipe, and being selectively openable when said extraction member is associated with a relative spout, and wherein the introduction of pressurized air inside the container determines a relative movement of separation of the lid and the container.

2. The device as in claim 1, wherein said air passage pipe comprises an open end defining a housing segment for at least the upper part of said spout.

3. The device as in claim 2, wherein the closing valve member comprises a slider element provided with a cavity open toward the housing segment and with one or more delivery holes, said cavity and said delivery holes being able to put the housing segment in fluid communication with the remaining part of the air passage pipe.

4. The device as in claim 3, wherein the closing valve member comprises an elastic element and an abutment element, said abutment element being disposed fixed inside the air passage pipe and said slider element being selectively movable with respect to the abutment element, so that the delivery holes can pass from a position outside the abutment element to allow the passage of air, to a position inside the abutment element to impede the passage of air.

5. The device as in claim 1, comprising holding means, associated with the air passage pipe in the housing segment, and able to be selectively activated in order to temporarily hold the spout inside the housing segment, at least during the separation step of the extraction member and the container.

6. The device as in claim 5, wherein the holding means are of the gripper type.

7. The device as in claim 1, comprising an actuator element, which can be selectively activated to move the extraction member nearer to/away from the relative container.

8. The device as in claim 7, wherein a plurality of said extraction members are associated with the same actuator element so as to simultaneously act on a mating plurality of containers.

9. A method for opening containers for liquids, to remove relative lids or capsules from said containers, by means of one or more extraction members, said lids being conformed to define a spout with a hole in it to allow the liquid to come out of the container, comprising at least a first insertion step, in which a relative linear movement of approach of said extraction members and said containers is made and in which at least the upper part of said spouts is inserted into an air passage pipe provided inside a relative extraction member, determining the automatic opening of a closing valve member disposed along said air passage pipe, a second step of blowing in pressurized air through the air passage pipe and the spout as far as the inside of the container so as to determine the separation of the lid and container, and a third separation step, in which a relative movement of separation of said extraction members and said containers is carried out.

10. The method as in claim 9, wherein at least in the third separation step, the spouts are temporarily held inside the extraction members by means of holding means.
